(19) United States
(12) Patent Application Publication
(10) Pub. No.: US 2006/0172705 A1
(43) Pub. Date: Aug. 3, 2006

(54) PREDICTIVE MODELING SYSTEM FOR SPECTRUM USE

(75) Inventors: Sanjay Parthasarathy, Edina, MN (US); Anoop K. Mathur, Shoreview, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 10/906,066

(22) Filed: Feb. 1, 2005

(51) Int. Cl. H04Q 7/32

(52) U.S. Cl. 455/67.11

(57) ABSTRACT

A system for predicting portions of the spectrum to be available for communications. Data of spectrum usage over time and availability may be obtained. An analysis of the data may be made and then a prediction may be inferred as to the present and future availability of various portions of the spectrum for use. The system may increase the usability of the spectrum.

### BACKGROUND

The present invention relates to wireless communications, and particularly to spectrum use for such communications. More particularly, the invention relates to use in a crowded spectrum.

The wireless spectrum is becoming crowded with increasing traffic for commercial, civilian and military use. There appears to be a need to achieve greater accessibility to unused portions of the spectrum without encountering unforeseen obstacles. SUMMARY

The invention involves predicting portions of the spectrum to be available for communications. Data of spectrum usage over time and availability may be obtained. An analysis of the data may be made and then a prediction may be inferred as to the present and future availability of various portions of the spectrum for use. The invention may increase the usability of the spectrum.

### BRIEF DESCRIPTION OF THE DRAWING

FIG. 1 is a block diagram of a system that may be utilized for predictive modeling for spectrum use;

FIG. 2a is a graph showing frequency usage over time;

FIG. 2b is a graph revealing a prediction of success of transmission versus time;

FIG. 3 illustrates frequency hopping as a graph of frequency slots versus time slots;

FIG. 4 is a graph of a predictive model contour;

FIG. 5 is a block diagram of a predictive model controller having an input of parameters relating to spectrum usage and computing spectrum availability for use by a transmitter/receiver device; and

FIG. 6 illustrates a model predictive control for frequency hopping which is illustrated in the form of frequency slots versus time slots.

### DESCRIPTION

There may be holes, portions or frequencies available in a crowded spectrum. The term “holes” in the present description may mean portions available for present and future use in the spectrum. These holes in the spectrum may be exploited. However, the holes could be dynamic; for instance, a device may be transmitting at different frequencies at unscheduled times or at the same frequency on an infrequent basis. If the holes could be predicted, an intelligent wireless system could guarantee performance and secure communication in the face of a crowded spectrum, system uncertainties, jamming signals and interference.

A model of system use of a spectrum may be built with its basis in time measurements and times of which frequencies are being used and their amount of usage. The measurements may be transcribed into a topology of frequency use with a mathematical model. The model may be stochastic, i.e., involving a statistical and probability approach. The model may also include heuristics to be input by the user, in that the model be self-corrective. It may be adaptive in that it can “learn” from usage in a communication system.

The model may be used predictively to determine where the next hole (i.e, next available frequency slot) in the spectrum will be with a reasonable level of confidence, i.e., degree of probability. Then a transmission may be made at the noted frequency hole during the predicted time of availability. The present control system may monitor and record the successes and failures of transmission, and react to failures, jamming or other interference of transmission.

A stochastic model may be used to internalize the topology of frequency use. Afterwards, the model may be invoked at certain discrete intervals to predict an occurrence of and/or when and where the holes in the spectrum will be. The control system may then determine whether a transmission at the predicted hole or frequency is successful. If not successful, the system may take remedial action by retransmitting (if the interfering signal's duration is known or internalized in the stochastic model) or by looking for other holes that can be used for transmitting messages.

The stochastic model may use a variety of tools to internalize the frequency topology. Such tools may include Markov processes (hidden or embedded in some instances). A suite of predictive tools that may be used for the model includes model predictive control (MPC), internal model control (IMC), and stochastic control techniques. The tools may be used in the same manner that they be used in predicting computer usage. Computer usage predicting may be noted in an article entitled “Real-Time Adaptive Resource Management”, by A. Pavan et al., “Integrated Engineering”, pp. 2-4, Computer, July 2001.

The stochastic model and control algorithms may be embedded in the control system or device that is used for transmission and/or reception of signals. The model may be also distributed among a set of transmission devices to ensure redundancy in the event of failure of some devices in the set or network.

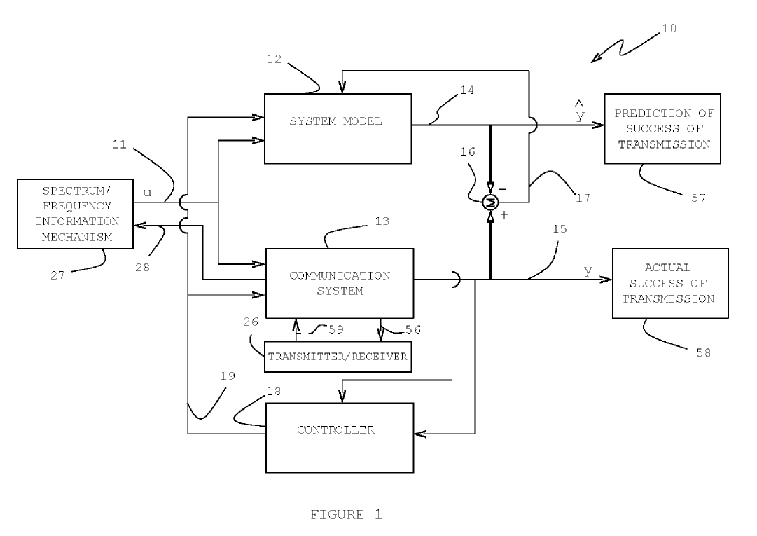

FIG. 1 is a block diagram of a system 10 that may be utilized for predictive modeling for spectrum use. From a spectrum/frequency information mechanism 27, a signal 11 may be designated as “u” incorporating frequency usage over time, which would include the times and durations of use at the respective frequencies of the spectrum. Signal 11 may go to a system model 12. An output signal 14 from system model 12 may be
ŷ
which provides a prediction of success of transmission, as noted by indication 57, or a figure of metric like Quality of Service (QoS). QoS may include success of transmission, timeliness of the message (or latency) and the integrity of it. Signal 11 may also go to a communication system 13 which may include a transmitter 26 to be used. Transmitter 26 may receive its control and monitoring from the communication system 13 via a connection 56. Transmitter 26 may provide its frequency and time usage of the spectrum to the communication system 13 via connection 59. The frequency and time usage of the spectrum may go from communication system 13 to spectrum/frequency information mechanism 27 via connection 28. An output signal 15 from communication system 13 may be “y” which indicates the actual success of a transmission, as noted by indication 58, or QoS. Signals 14 and 15 may go to an adder-subtracter 16 where signal 14 may be subtracted from signal 15 to result in an error signal 17 which may be fed to system model 12 to adjust and/or update the prediction (or system) model. The error signal 17 may be the difference between the actual success of transmission and the predicted success of transmission. The signal 17 may also have a corrective effect on the system model 12 and its output 14.

The signal 14 may be fed to a controller 18 to provide a prediction of success of transmission or QoS at a particular frequency at a certain time, or a plurality thereof. Signal 14 may have an adjusting effect on the controller 18 relative to an output signal 19. Signal 15 may be input to controller 18 to indicate if there was an actual success of transmission or QoS. Signal 19 may be output from controller 18 to provide input for a possible change of the frequency and time of usage by communication system 13. Signal 19 may also be input to system model 12.

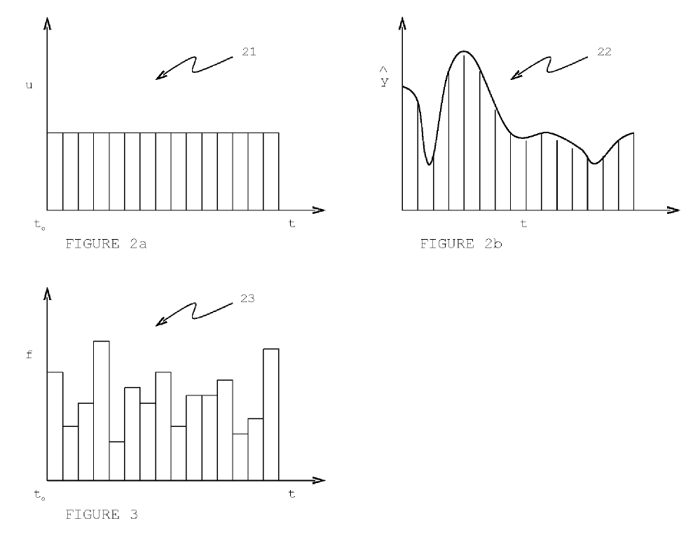

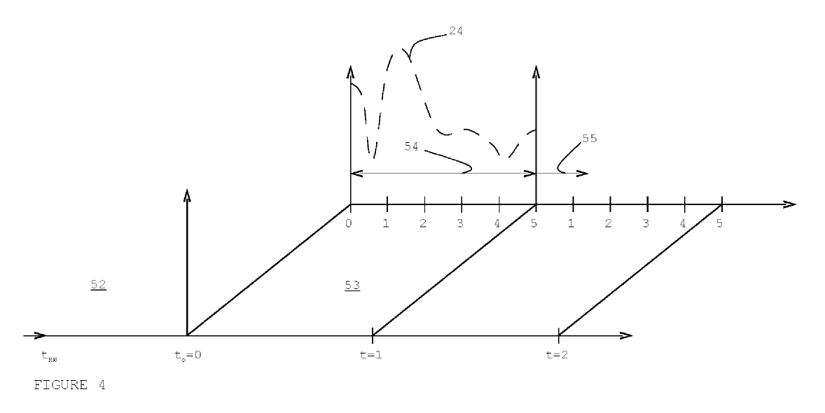

FIGS. 2a and 2b are graphs having curves 21 and 22, respectively, of u (frequency usage) over or versus time, and
ŷ
(prediction of success of transmission) over or versus time t. One may note that if u is constant over time as shown with curve 21 in FIG. 2a, the system model 12 output
ŷ
of QoS or prediction of success of transmission curve 22 of FIG. 2b may be non-constant over time t. This could happen due to interference signals in the spectrum. The time scale may be marked off in equal increments which are similar for curves 21 and 22. One may ask what should be the next u value be to maximize the QoS value signal
ŷ
QoS may depend on a transmitter's use of a hole in the spectrum and what other transmitter may be using that particular hole and at what times. Here is where the prediction may come in. At any one time, much of the spectrum may be in use. Some areas of the spectrum may be more crowded than other areas. If the present predictive modeling system were used by all actual and prospective spectrum users, usage of the spectrum could be increased many times.

Prediction may involve predictive de-confliction. A success factor may involve several parameters of significance which are those of QoS such as latency, i.e., time delay. Even though the transmission may be successful, it may not be of much good if it is slow getting to its expected recipient and its lateness results in the transmission being of less or no value. There may be a factor of message integrity to consider in transmissions. The message may succeed but there may be one bad bit in a digital transmission, which may affect the integrity of the message in the transmission. Integrity of the message may be of particular concern in a secure communication where the transmission succeeds but the encryption or decryption does not work.

Signal 11 u may indicate a particular frequency that a transmitter is using over time or it may indicate amplitude and frequency usage at certain moments and durations of time. The transmitter may be hopping frequencies; for example, it may hop to preset frequencies at prescribed times. A software program may be utilized to perform such frequency hopping. Graph 23 of FIG. 3 shows an example of frequency hopping which is illustrated in the form of frequency slots versus time slots. The duration of the time slots may be in the range of milliseconds. Thus, the transmitter may hop from one frequency to another many times a second or minute. The transmitter and receiver operations should be configured relative to this graph of information, as applicable, which may be in a form of a table. However, the table may change dynamically. The actual usages u indicated by signal 11 may dynamically change the table in accordance with the overall system 10 of FIG. 1. The signal 11 u may be a case of frequency hopping or the frequency at which the transmitter is broadcasting. Prediction of holes in a spectrum may be useful for planning frequency hopping. Hopping may involve encryption and integrity of the messages being sent. There may be some redundancy as desired in certain circumstances.

The error output 17 of overall system 10 may update and adjust the system model 12 providing the prediction signal 14. The prediction signal 14
ŷ
may be sent to the controller 18 as guidance in forming the signal 19 indicating available frequencies and times for the transmitter of the actual communication system 13 to use. The controller 18 may do a multi-step prediction far ahead of the present moment, which provides the best control of spectrum selection or frequency hopping. This approach may be an optimization of frequency hopping. Such action may be in real-time. The simulation may be faster than real time to determine the control action to take at the present time. Changes from moment to moment of the predictions and their bases may be taken into account.

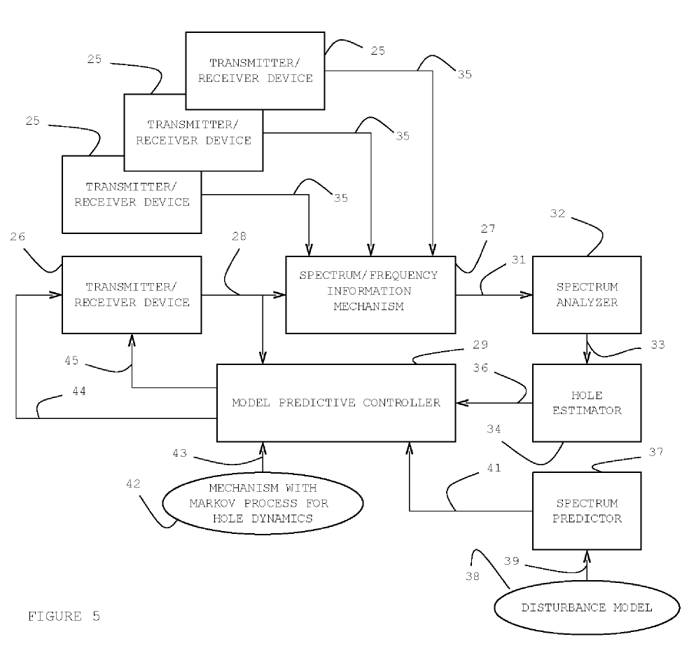

FIG. 4 illustrates the real world 52 during t_{RW} up to tₒ=0 and a prediction of what the system might be able to do after tₒ=0 in the simulated world 53, for instance, in the 5 time slots up to t=1 to the right as shown by curve 24 along simulated time 54. At time line 55, the input for the controller 18 may again be computed and implemented. At t=1, the prediction may be recomputed, i.e., updated. That may be needed since there are ongoing environmental changes, frequency usage changes, and so on. The prediction may be updated for the next 5time slots. The number of time slots for each prediction or update may be arbitrary.

For time line 54, the prediction may be a of a predictive model contour 24 at the output 14 of the system model 12. System model 12 of overall system 10 may be realized with model predictive control (MPC), internal model control (IMC), or other like software and stochastic control techniques.

Relative to predictions, there may be a receding horizon control (RHC) in which the prediction horizon may recede if transmission time is limited. In other words, predictions are not made beyond the time that the transmission is scheduled to stop. Here, the overall system 10 may go into a terminal state. Although in some frequency spectrums, usage has no terminal state, e.g., cell telephones.

There may be a number of transmitter/receiver (T/R) devices connected with a centralized predictive modeling system which may have a central processor making decisions for assigning frequencies for these devices. However, the T/R devices may be decentralized and the decisions for assigning the frequencies be distributed to each device. Some de-confliction among the various devices may be needed. So even if the decisions for frequencies are decentralized, they are not necessarily totally decentralized. Each of the T/R devices may have a spectrum analyzer and a processor for making its own decisions about frequency use. There may be interconnections among the devices. Each may take into account the whole frequency spectrum or some a priori assigned portions of the spectrum to various T/R devices.

Frequency selection by a T/R device may depend much on who is broadcasting in the particular geographical area where the specific T/R device is located. An analogous situation may be a railway system having various geographical areas where each train is located. A specific train may have a particular itinerary which may involve certain geographical areas that it may be going through relative to getting to its destination. There may be an interchange of information. Theoretically, the centralization and decentralization approaches should result in the same answers, whether a frequency selection for a pair of transmitter and receiver devices or a rail selection for a train. The centralized approach may be regarded for selecting the global optimum for all units. The decentralized approach may be regarded for selecting the local optimum for the local unit having a mission. The latter may often have more concern for the local environment rather than the global environment. Decentralization may become less expensive than centralization. Decentralization may also be computationally simpler. The decentralized system may provide greater probabilities for selected frequencies for an individual T/R device than the centralized system.

If there are two sets of transmitter/receiver devices wanting to use the same frequency, there may be a negotiation involving time-share on that frequency which may be similar to track-share of a railway system. One may incorporate partitioning time/frequency/code (PTFC) to resolve conflicts between the sets. There may be a code with established techniques for distributing information. So there may be code distribution among the sets or units. Some approaches that may be used are code divisional multiplexing (CDM) with application for cell phones, and time domain multiplexing (TDM). There may be a software-defined radio which involves and is leveraged by the present adaptive predictive model control (PMC). The PMC may be adaptive in that it is improving at every time-instant and helps one to find and use quick and efficient solutions successfully in a decentralized system.

One end goal is a rapid deployment of wireless networks in a new environment. This may be a good use. A bad use may be the jamming of certain frequencies and making holes in the jamming for one's own information or use. Such jamming may be coded much like the enigma machine approach used during WWII. The other side of a conflict may jam GPS and communication signals. There may be noise in the regular signals, possibly including a code in them.

A model based control may do a prediction from a certain one time such as to. It may be rather easy to implement in the present invention a transmitter/receiver device, a sensor, plug and play, some numbers, slots opening up, autonomous selection, and/or reconfiguration by the controller whether it be centralized or decentralized.

An example of a system for model prediction of spectrum use may include a stochastic model of spectrum use base on a time-sequence usage of frequencies, an adapting model based on environmental conditions (i.e., present usage, future usage, spots, locations and interference), model based controller development and a model predictive controller.

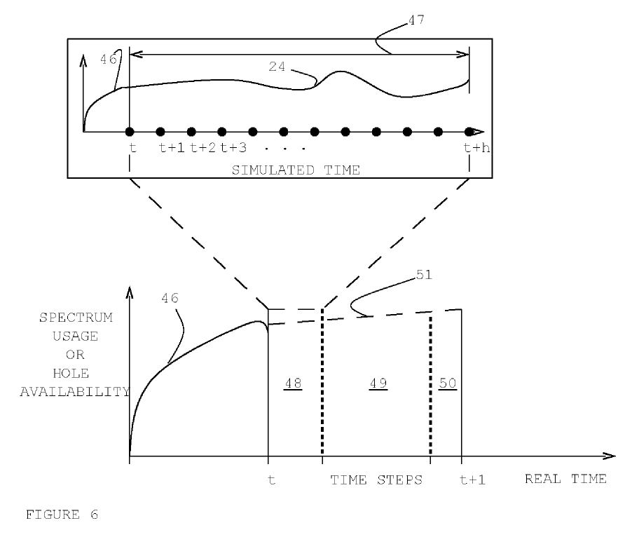

FIG. 5 reveals a schematic of a multiple of transmitter/receiver devices in conjunction with a model predictive controller 29. Three T/R devices 25 are shown but there could be many more or fewer T/R devices using the spectrum that a T/R device 26 would like to use. Outputs indicating the usage of the various frequencies of the various T/R devices 25 as signals 35 may go to a spectrum/frequency (usage) information mechanism 27. An illustrative example of finding a hole for a T/R device 26 that one may want to use is shown. The T/R device 26 may output a signal 28 indicating its spectrum use. Signal 28 may go to the information mechanism 27 and the model predictive controller 29. From the spectrum usage information of the T/R devices 25 and 26, an output signal 31 representing that information may go to a miniaturized spectrum analyzer 32. The spectrum may be analyzed in view of the T/R device usage. Analysis results in the form of a signal 33 may go to a hole estimator 34, which in view of the spectrum analysis results, particularly as accumulated over time, may provide a history of holes and estimates of where the holes in the spectrum appear and at what times and durations. The hole estimator 34 may send estimates, based on the information in signal 33, as a signal 36 to the model predictive controller 29.

A spectrum predictor 37 along with a signal 39 from a disturbance model 38 may predict “surge events”, interruptions and upcoming transmissions in the spectrum, and provide that information as a signal 41 to controller 29. A mechanism 42 may provide a Markov process for hole dynamics as a signal 43 to the controller 29 to aid the controller in dealing with the estimation of holes signal 36 from hole estimator 34 in conjunction with the other signals 28 and 41 received by the controller 29. Controller 29 may use a spectrum model and a history of holes to determine the frequency hole most likely to be empty for the next “x” milliseconds, seconds or minutes. A signal 44 indicating a broadcast frequency selected or a frequency hop sequence in view what is predicted to be available may be sent to the T/R device 26 to be used. Also controller 29 may indicate with a signal 45 to device 26 how many seconds (i.e., x seconds or the like) that the hole or holes (if a hop sequence) specified in signal 44 will likely be available. Also, signal 45 from controller 29 may indicate the future times that certain holes will likely be available.

FIG. 6 reveals an approach of the model predictive controller 29. As noted above, spectrum usage and/or hole availability information may be provided to controller 29. The controller may use observed past and present spectrum usage and a history of holes as shown by curve 46 to form a model for prediction. The model may be used for predicting the availability of the spectrum for usage. The predictions may use the model for the next “h” steps (with an assumed input and noise profile). The h steps may extend for a horizon length “h” as shown by line 47 in FIG. 6. Predicting for the future as represented by simulated time (i.e., t+1, t+2, t+3,... t+h) may be shown by the predictive model contour 24. That may be the “predict” stage 48 which is the first phase of the model predictive control as shown in the spectrum usage or hole availability versus real time graph with time steps t and t+1 shown on the abscissa axis. The next stage 49 may involve the use of the predictions to compute an optimal input at “t+1”. At the next stage 50, the computed input 51 may be implemented at “t+1”. Occasionally, the model that approximates the profile 46 may be updated or adapted, such as every 15 minutes or so.

In the present specification, some of the material may be of a hypothetical or prophetic nature although stated in another manner or tense.

Although the invention is described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. A modeling system for finding at least one hole in a spectrum for a transmitter, comprising:
a spectrum information mechanism having a first input for receiving information related to past and present spectrum usage, and having an output for summarizing relevant spectrum usage;
a spectrum analyzer having an input connected to the output of the spectrum information mechanism, and having an output for providing analyses of the spectrum;
a hole estimator having an input connected to the output of the spectrum analyzer and having an output for providing hole estimates and a history of holes; and
a model predictive controller having a first input connected to the output of the hole estimator, a second input connected to an output of the transmitter, and having an output for providing predictions about holes including their frequencies, times and periods of availability.

2. The system of claim 1, wherein the output of the model predictive controller is connected to an input of the transmitter.

3. The system of claim 2, further comprising:
a spectrum predictor having an output connected to a third input of the model predictive controller; and
a disturbance model having an output connected to an input of the spectrum predictor.

4. The system of claim 3, further comprising a stochastic processor having an output connected to a fourth input of the model predictive controller.

5. The system of claim 4, wherein the stochastic processor is a Markov processor for hole dynamics.

6. The system of claim 5, wherein the spectrum predictor along with a signal from the disturbance model may provide information about surge events to the third input of the model predictive controller.

7. A method for planning effective spectral use by a transmitter, comprising:
gathering information about the use of the spectrum;
providing the information to a stochastic process;
developing a model predicting frequencies and times and probabilities of successful transmission by the transmitter;
transmitting with the transmitter on predicted frequencies and times from the model;
noting the successes and failures of transmission by the transmitter on the selected frequencies and times;
comparing the successes and failures of transmission with the predicted probabilities of successful transmission by the transmitter; and
using results of the comparing the successes and failures for refinement of the model.

8. The method of claim 7, further comprising predicting from the model, as refined, frequencies and times and probabilities of successful transmission by the transmitter.

9. The method of claim 8, further comprising:
transmitting with the transmitter on predicted frequencies and times from the model, as refined;
noting the successes and failures of transmission by the transmitter on the selected frequencies and times;
comparing the successes and failures of transmission with the predicted probabilities of successful transmission by the transmitter; and
using results of the comparing the successes and failures for refinement of the model.

10. The method of claim 9, further comprising repeating the method of claims 8 and 9 as desired.

11. A spectrum use system comprising:
a communication system connected to a transmitter/receiver device;
a system model connected to the communication system;
a controller connected to the system model and communication system;
a spectrum information mechanism connected to the communication system and the system model; and
a differencing device connected to the system model and the communication model.

12. The spectrum use system of claim 11, further comprising:
a spectrum information mechanism connected to the system model and the communication system; and
a transmitter connected to the communication system.

13. The spectrum use system of claim 12, wherein:
an output of the communication system may be an indication of success of transmission for certain frequencies and times;
an output of the system model may be an indication of a prediction of success of transmission for certain frequencies and times;
an output of the differencing device may be the difference between the indication of success of transmission for certain frequencies and times and the prediction of success of transmission for certain frequencies and times; and
the difference from the differencing device may be input to the system model.

14. The spectrum use system of claim 13, wherein:
the output from the system mode to the controller may be an adjustment within the controller of the input from the communication system; and
the difference from the differencing device to the system model may be an adjustment of the indication of the prediction of success of transmission.

15. A means for predicting available holes and times in a spectrum comprising:
means for providing information about spectrum usage;
means for spectrally analyzing the information about the spectral usage;
means for estimating holes from results of the spectral analyzing; and
means for forming a model of the spectrum revealing available holes and times based at least partially on information from the means for estimating holes.

16. The means of claim 15, wherein the means for forming a model may utilize a stochastic process.

17. The means of claim 16, further comprising:
a means for predicting spectrum events; and
wherein the means for forming a model of the spectrum revealing available holes and times may be based at least partially on information from the means for predicting spectrum events.

18. The means of claim 17, wherein the model of the spectrum reveals available hop sequences and times.

19. The means of claim 18, wherein the stochastic process is a Markov process.

20. A modeling system comprising:
a system model having a first input for frequency usage over time and an output for a prediction of success of transmission;
a communication system having a first input for frequency usage over time and a first output for indicating an actual success of transmission;
a controller having a first input connected to the first output of the communication system, a second input connected to the output of the system model, and an output connected to a second input of the communication system and a second input of the system model; and
an adder-subtracter having a first input connected to the first output of the communication system, a second input connected to the output of the system model, and an output connected to a third input of the system model for providing a difference between the actual success of transmission and the predicted of success of transmission.

21. The modeling system of claim 20, further comprising:
a transmitter having an output connected to a third input of the communication system and having an input connected to a third output of the communication system; and
a spectrum/frequency information mechanism having an output connected to the first input of the system model and to the first input of the communication system, and having an input connected to a second output of the communication system.

22. A method for spectrum modeling for use of a transmitter, comprising:
obtaining information about uses, including use of the transmitter, of the spectrum in terms of frequencies, times and durations;
performing spectral analyses of the information;
estimating holes in the spectrum from the spectral analyses;
predicting the spectrum condition relative to unexpected transmission events;
importing a stochastic process for dealing with hole dynamics; and
feeding into a model predictive controller information including that of estimating holes in the spectrum, predicting the spectrum condition relative to unexpected transmission events, and/or with at least one stochastic process to process the information into a model of the spectrum revealing holes and their periods most likely to be available.

23. The method of claim 22, further selecting the frequency or frequencies or hop sequence of frequencies and times and durations determined at least partially according to the model of the spectrum for transmission by the transmitter.

24. A means for spectral modeling for transmitter use comprising:
means for constructing a system model;
means for providing spectrum use information to the system model;
means for attaining a prediction of success of transmission at certain frequencies and times from the system model;
means for using the transmitter at the certain frequencies and times;
means for attaining information about actual success of transmission by the transmitter at the certain frequencies and times;
means for determining a difference between the actual success of transmission by the transmitter at the certain frequencies and times and prediction of success of transmission at certain frequencies and times from the system model; and
means for providing an adjusted system model with the difference.

25. The means of claim 24, further comprising:
means for providing spectrum use information to the adjusted system model;
means for attaining a prediction of success of transmission at certain frequencies and times from the adjusted system model;
means for using the transmitter at the certain frequencies and times;
means for attaining information about actual success of transmission by the transmitter at the certain frequencies and times;
means for determining a difference between the actual success of transmission by the transmitter at the certain frequencies and times and prediction of success of transmission at certain frequencies and times from the adjusted system model; and
means for providing another adjusted system model with the difference.

26. The means of claim 25, further comprising a repeat of the means of claim 2 for another adjusted system model.
